(19) United States
(12) Patent Application Publication
(10) Pub. No.: US 2006/0168184 A1
(43) Pub. Date: Jul. 27, 2006

(54) Method of operating a network management station

(75) Inventor: Markus Rentschler, Dettingen (DE)

Correspondence Address: THE FIRM OF KARL F ROSS, 5676 RIVERDALE AVENUE, PO BOX 900, RIVERDALE (BRONX), NY, 10471-0900, US

(73) Assignee: Hirschmann Automation and Control GmbH

(21) Appl. No.: 11/337,931

(22) Filed: Jan. 23, 2006

(30) Foreign Application Priority Data
Jan. 22, 2005 (DE) 102005003059.9

(51) Int. Cl. G06F 15/173

(52) U.S. Cl. 709/223; 709/226

(57) ABSTRACT

A network management station connected to a network infrastructure is configured for the acquisition and registration of at least a [portion of the network infrastructure. A selected region only of the network infrastructure is displayed graphically on the screen of the network management station.

### CROSS REFERENCE TO RELATED APPLICATION

This application is based upon German application 10 2005 003 059.9 filed 22 Jan. 2005 under the International Convention.

### FIELD OF THE INVENTION

My present invention relates to a method of operating a network management station and, more particularly, to a method which acquires a selected region of a network infrastructure and displays it as a concomitant to management of the network.

### BACKGROUND OF THE INVENTION

U.S. Pat. No. 5,185,860 describes an automatic discovery system for a management or administration system of a network which determines the network devices and connections or topology of the network.

In U.S. Pat. No. 5,276,789, a graphic display or registry system has been described for a management station for the graphic indication of the topology of a network which allows various views (including internet views, segment views and node views) as selected by the user.

German patent document DE 697 20 857 T2 and corresponding U.S. Pat. Nos. 6,012,095 and 6,189,038 describe a notifications framework for improving the operation of a management station in a network by the integration of information from a multiplicity of different administrative protocols. The network has a plurality of management stations, namely a translator which is connected with the network for receiving event data elements corresponding with different management protocols from the network and translating the event data elements into respective canonical data structures. Each of the canonical data structures encompasses an attribute field for holding an attribute that can be interpreted by one of a plurality of management stations of the network. The translator translates an event data element in the canonical data structure by extracting attributes from the event data element and which can be stored in the attribute field. In addition, the management stations include a notifications framework which is connected with the translator to receive the canonical data structure. The framework is configured to forward a canonical data structure with a specific attribute field to a consumer component which is connected with the framework. The consumer components have been previously registered with the framework to receive any canonical data structures with the particular attribute fields.

### OBJECTS OF THE INVENTION

The principal object of the present invention is to provide a method of operating a network management station which is improved over the management stations and methods of the documents mentioned herein and which are included in their entireties by reference.

Another object is to provide an improved network management method which increases the versatility and utility of a management station of the prior-art type with minimal need for additional resources.

Still another object is to provide an improved method of operating a network management station, e.g. of the type described in the aforementioned patents, which makes the station easier to use.

### SUMMARY OF THE INVENTION

These objects are attained in accordance with the invention in that a specific region (but less than all) of the network infrastructure is acquired by the network management station and, in this region, the elements of the network structure are acquired (i.e. data as to such elements/region are gathered or collected), and the elements/data/region are graphically displayed. As a consequence, it is no longer required to acquire or access the entire network structure and to display it, but rather based upon predetermined criteria selected regions can be selected which are acquired/accessed and are graphically displayed on the network management station. In this way it is possible to increase greatly the processing speed for the acquisition and the graphic display, while simultaneously enhancing the oversight capabilities of the selected region by the graphic display.

The network management station, which is preferably a central network management station, collects connection data with respect to the network nodes of the network infrastructure and the terminal devices thereof in the specific acquisition region in order to prepare these connection data for a graphic display which can show the physical topology of the network, for example, graphically as an image on a display screen of the network management station. Since the acquisition region no longer encompasses the entire network infrastructure, the preparation of this connection data and the subsequent graphic imaging can occur very rapidly and in close to real time so that the image displayed on the display screen of the network management station can represent that region of the network almost in real time. In this system, the network nodes transmit information as to the terminal devices connected directly to their interfaces (network ports) and neighboring terminal devices which can be reached through the respective ports. This information, in the form of connection data or converted to connection data, is transmitted to the network management station or is available at the nodes so that such data can be called up and collected by the network management station when it interrogates these nodes.

In this connection data, there must appear an identification of each terminal device in the form of a singular (for the given network) code, address or identifier. This can, for example, be the respective MAC address, IP address or some other freely selectable but singular name (i.e. a name possessed by only one unit of the network). Such a freely selectable name can, for example, be assigned by the user of the network or automatically by the network management station.

From the connection data, preferably also the management access (especially the IP address) of at least one other neighboring terminal device is called up, to the extent such a terminal device may be provided. As a result, it is possible for the network management station, starting from a known terminal device in the region to be acquired, to access one terminal device after another in succession and thereby collect the connection data appropriate to each in the region of the network infrastructure to be displayed.

Thus the connection data of a network node which is there locally available, is so constructed that for each physical interface (network port) of aq network node, a list is provided of the neighboring terminal devices which are directly connected to this interface. This list can be filled in with information by the user of the network and, indeed, even independently of the terminal devices which are actually in place. Moreover, it is conceivable that this list be filled in with additional information or updated whenever a terminal device is connected or replaced or removed. Additionally, information as to the properties of the respective interfaces and the terminal devices connected thereto can be communicated and can form components of the connection data. The connection data and the additional information can also be displayed in whole or in part graphically on the display screen of the network management station. Among the additional information as to the characteristics of the respective interface or port, for example, are the VLAN-IDs active protocol as well as the port protocol and port state. The network management station collects these local connection data from each network node in the acquisition region and assembles the lists of connection data so that the terminal devices and the connections between the terminal devices in the acquisition region as well as the acquired region of the network infrastructure can be displayed either completely or in segments or in part.

The network management station can display graphically the connection data as well as the additional information, for example, by one or more or a combination of the following processes:

1. Automatic positioning of detected network nodes and the associated connection lines.

2. Use of predefined placement templates (layouts, matrices) for positioning of network nodes and the connection lines extending between them.

3. Manual placement of network nodes and their interconnection lines with the possibility of converting the manual positioning to a template.

4. Display of network nodes which do not have the described capacity for detecting their directly neighboring network nodes or terminal devices in the graphic imaging (topology display) as a “shared segment” (nonswitched Ethernet segment).

The connection data and optionally the additional information need not be used only for the graphic display of the selected region of the network infrastructure, but can also be used for the accenting or accentuating of certain portions or features of the network topology by the displayer. This can be achieved by a colored accenting of certain connection lines and/or terminal devices which are intended to function cooperatively or in unison or, for example, form a VLAN association, a common subnet, a common ring structure, or a common bus or the like.

With operator/manager accenting or even in the display of the selected region of the network infrastructure, in accordance with a further feature of the invention, the acquired region of the network structure is monitored or examined for its correctness or for defects or errors, and any defects which are found are graphically indicated, for example on the already operator-accented image but in another color. The monitoring or examination of the acquired network infrastructure can determine its correctness or any defects with respect to whether a particular ring configuration or bus structure is physically permissible, whether the terminal devices which are introduced are permissible at the locations in the network infrastructure allotted to them, whether these terminal devices or their interfaces and the connections between them are proper and can operate effectively or may embody interruptions, short circuits, or the like. In the case of, for example, a ring structure, it should not be completely closed, but always should have at least one interruption site to prevent unlimited circulation of data packets. Should an interruption site not be provided, one can automatically be generated by the network management station of the invention and, above all, immediately displayed thereby.

Through the network management station, the possibility of a manual switching between various display modes can be ensured. In one or another of these display modes, various functional relationships of the acquired region of the network infrastructure (network topology) can be evoked. For example, a ring structure may be displayed as a circle or an ellipse, a bus structure displayed as a line or tree or branched structure, or the like.

The network management station can implement algorithms to ensure consistency of the connection data and optionally also the additional information (consistency testing) and can be designed to recognize error configurations and signal these to the operator. One such error configuration arises when, for example, incompatible redundancy protocols are used to configure two ports which are connected together and are physically impermissible.

The connection data present on the network management station can also be used for the verification and configuration of other processes and other network protocols, for instance for the configuration of a DHCP server or for the verification of its configuration. Furthermore, the network management station can be so enabled that a once pre-configured or detected or scanned network infrastructure can be defined as a set-point structure, which can then be monitored as to its content or completeness and deviations signaled to or by the network management station. The “topology” will then be an image of the basic infrastructure of the network.

### BRIEF DESCRIPTION OF THE DRAWING

The invention will be described in greater detail with reference to the accompanying drawing, in which:

FIG. 1 is a diagram showing a network management station with the network infrastructure to which it is connected for carrying out the method according to the invention;

FIG. 2 is a diagram similar to FIG. 1 illustrating another display mode; and

FIG. 3 is another diagram similar to FIG. 1 illustrating still another display mode.

### SPECIFIC DESCRIPTION

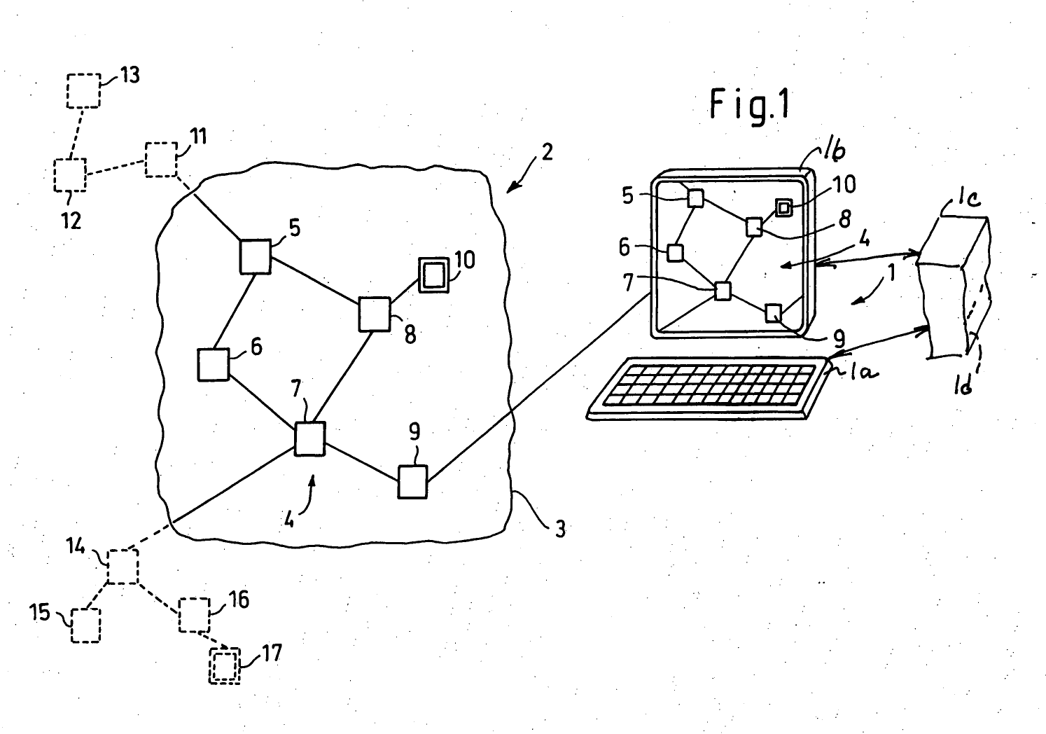

FIG. 1 shows a network management station 1 which can be, for example, an ordinary PC having a keyboard 1b, a display screen or monitor 1b, a CPU 1c, a memory unit 1d and any other appurtenances common to a computer work station connectable to a network. This network management station 1 is connected to a network infrastructure 2 which can have any optional configuration for a LAN or other network. According to the invention, a selected region 3 of this network infrastructure is to be displayed or imaged on the screen of the network management station 1 and, for this purpose, the network management station is configured to select the region 3 which is less than all of the network infrastructure. This can be effected automatically, based on input and rules provided by a user, or manually by user selection of the region 3 on the screen. Within the region 3 to be displayed, reference character 4 represents the elements of the network infrastructure which are to be displayed and which include units 5 to 10 which are interconnected and their connection lines.

The display is extended to show not only the region 3 of the network but connections to other devices 11, 12, 13, for example, of the unit 5 as well as the terminal devices 14-17 of the unit 7. These devices 11 to 17 are indeed components of the total network infrastructure, but because of the rules established for the display have not been shown on the screen as part of region 3. The display is such that the network infrastructure 4 is represented on a 1:1 basis without further transformation.

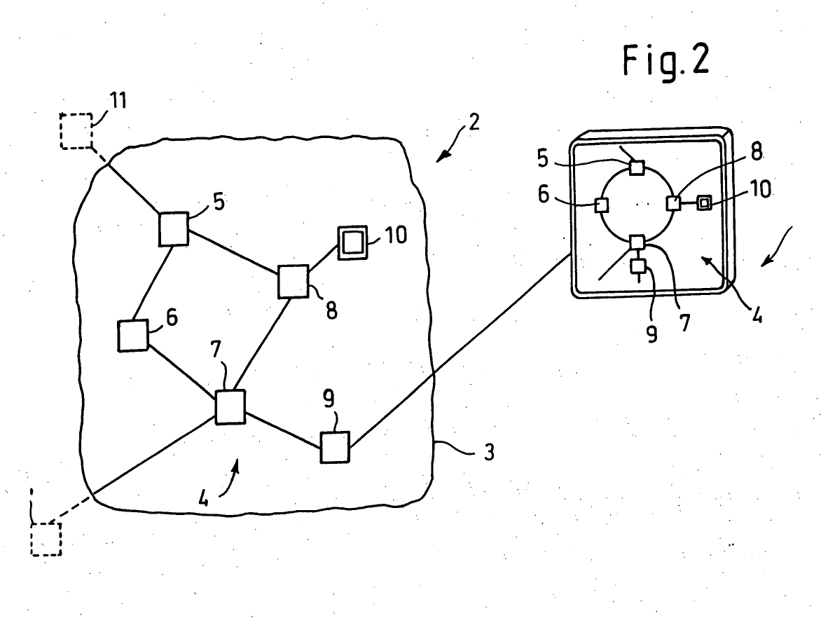

FIG. 2 also shows a network management station 1 with the network infrastructure 2 connected thereto, but wherein, by contrast with FIG. 1, the region 3 of the infrastructure which is displayed is imaged not as its physical structure, but in a transformed configuration, i.e. as a ring structure.

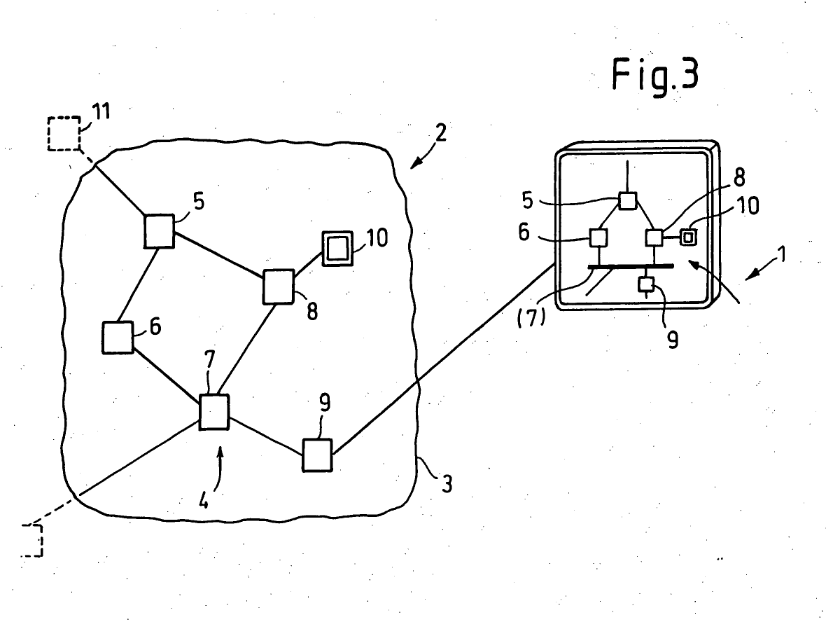

By analogy to FIG. 2, FIG. 3 shows the network management station 1 with the network infrastructure connected thereto, but with a display in which the topology of the region 3 is shown, not as a ring structure, but as a line structure on the screen.

For the selection and display of the region 3 of the network infrastructure which is to be displayer on the screen, I may use an algorithm for interrogating or scanning the network nodes as to the connection data collected thereby and communication of the collected data over the bus structure with which the network is provided.

An algorithm for interrogating and acquiring the connection data from the network nodes can utilize discovery protocols for the data collection and transmission like LLDP (IEEE 802.1 AB), the Cisco Discovery Protocol (CDP) or the like.

The information as to the connection data can be obtained by the known SNMP interrogation by the network management station to MIBs of the network nodes, the management information bases (MIBs) being preferably PTOPO-MIB, LLDP-MIB, CDP-MIB, or some other MIB.

For determining the bus structure which is available, a discovery protocol can be used which assembles the bus graphically for results based on the connections by means of shared Ethernet segments through the use of hubs (true bus structure) or based on the presence of devices. Protocols like LLDP, especially in accordance with the IEEE 802.1 AB standard, are not further transmitted by network nodes with switching functionality which are not LLDP compatible. This can lead disadvantageously to an interruption in communication of topology is data. This weak point arises because the LLDP packets with IEEE-Multicast addresses are basically filtered out at the next network node and are thus not further transmitted. This means that the LLDP standard cannot recognize the port status reliably. By the use of a non-IEEE-Multicast address for LLDP packets, which can be transmitted in addition to the packets with the IEEE addresses, this problem can be solved. In accordance with the invention, therefore, the LLDP protocol is expanded in the operation of the network management station. The packet transmission for packets with non-IEEE addresses can be switched on or off for each network node and each port as required.

The algorithm can determine which of the network nodes are to capture the interrogatories and the depth, in addition to the region of the network to which the interrogations are directed. The interrogation can begin always with a specific network note, especially the network node to which the network management station is connected and which has ascertained its neighboring nodes, and can then proceed to these neighboring nodes and then to the neighboring nodes of these. The region to be displayed (query depth) can, for example, be determined by continuing querying nodes until the display region of the screen is full, or by selecting the region at th network management station which has previously stored all of the connection data for the entire network infrastructure. In principle the entire network infrastructure can thus be acquired and using a kind of zoom function only a specific region of variable extent can be displayed on the screen of the network management station.

I claim:

1. A method of operating a network management station connected to a network infrastructure and configured for the acquisition and registration of a network infrastructure to be accessed, said method comprising the steps of determining a selected region of the network infrastructure; and acquiring and graphically displaying the network infrastructure of the selected region.

2. The method defined in claim 1, further comprising the steps of monitoring the network infrastructure of the selected region for correctness or defects, and displaying graphically detected defects.

3. The method defined in claim 2, further comprising the step of determining data and identifications from communications from network nodes of the network infrastructure of the selected region or by interrogation of network nodes of the network infrastructure of the selected region to which devices of the network infrastructure are connected.

4. The method defined in claim 3 wherein the interrogation of network nodes of the network infrastructure of the selected region to which devices of the network infrastructure are connected is effected in accordance with a Discovery Protocol.

5. The method defined in claim 4 wherein the Discovery Protocol is LLDP.

6. The method defined in claim 4 wherein the Discovery Protocol is CDP.

7. The method defined in claim 1 wherein a non-IEEE-Multicast address is used for LLDP packets which are sent in addition to packets with IEEE addresses.
